(19) United States
(12) Patent Application Publication
(10) Pub. No.: US 2006/0041102 A1
(43) Pub. Date: Feb. 23, 2006

(54) Implantable devices comprising biologically absorbable polymers having constant rate of degradation and methods for fabricating the same

(75) Inventors: Syed F.A. Hossainy, Fremont, CA (US); Stephen D. Pacetti, San Jose, CA (US); David C. Gale, San Jose, CA (US)

Correspondence Address: SQUIRE, SANDERS & DEMPSEY LLP, 1 MARITIME PLAZA, SUITE 300, SAN FRANCISCO, CA, 94111, US

(73) Assignee: Advanced Cardiovascular Systems, Inc.

(21) Appl. No.: 10/925,257

(22) Filed: Aug. 23, 2004

(51) Int. Cl. C08G 63/08

(52) U.S. Cl. 528/354

(57) ABSTRACT

Polymers that can form the substrate of an implantable medical device and form coatings for implantable medical devices and methods for their fabrication are disclosed, the coatings comprising polymers that are hydrolyzed at a substantially constant rate or that have been prepared so that they degrade at a rate closer to constant.

### BACKGROUND

Percutaneous transluminal coronary angioplasty (PTCA) is a procedure for treating heart disease, usually a lesion-occluded coronary arteries. A surgeon inserts a catheter assembly having a balloon portion through the skin into a patient's cardiovascular system by way of the brachial or femoral artery. The surgeon positions the catheter assembly across the occlusive lesion. Once positioned, the surgeon inflates the balloon to a predetermined size to radially compress the atherosclerotic plaque of the lesion and to remodel the artery wall. After deflating the balloon to a smaller profile, the surgeon withdraws the catheter from the patient's vasculature.

Sometimes this procedure forms intimal flaps or tears arterial linings. These injuries can collapse or occlude the vessel. Moreover, the artery may develop thrombosis and restenosis up to several months after the procedure and may require further angioplasty or a surgical by-pass operation. Implanting a stent into the artery can rectify the injuries and help preserve vascular patency.

In a related manner, local administration of therapeutic agents with stents or stent coatings has reduced restenosis. But even with the progress in stent technology in recent years, stents still can cause undesirable effects. For example, the continued exposure of a stent to blood can lead to thrombus formation itself, and the presence of a stent in a blood vessel can weaken the blood vessel wall over time, which may allow arterial rupture or the formation of an aneurism. A stent can also become so overgrown by tissue that it becomes less useful and that its continued presence may cause a variety of problems or complications. Therefore, biodegradable or bioabsorbable stents are desirable to diminish risks that would otherwise associate with the stent's continued presence after it is no longer needed at the treatment site.

Unfortunately, some biodegradeable or bioerodible polymers degrade such that they cause or exacerbate long-term inflamatory reactions. Bulk-degrading polymers frequently show little or no mass loss initially. But with time, especially at the end of their existence, the mass loss becomes more rapid, with a burst or increase release of small species, monomer, dimers, and trimers, along with a large amount of acid unavoidably generated by polymers that degrade by random hydrolysis. The body naturally neutralizes this acid and to that extent locally burdens the already fragile cells. Bulk-degrading polymers are needed that show a more constant mass loss so that the acid burden to the system may be spread out over a longer time period.

### SUMMARY

This invention relates to polymers, medical devices constructed with or from the polymers and related methods. In some embodiments, invention polymers have degradation kinetics as expected from a polymer that degrades in a bulk fashion. For instance, in some embodiments the polymers have degradation kinetics akin to a constant degradation rate. In some embodiments, the degradation kinetics are determined by measuring the slope of a best fit line fit to an initial portion of the polymer's degradation-versus-time profile, as described more fully below. In these or other embodiments, the slope of the line is K and ranges from 0.01 to 0.7; 0.02 to 0.65; 0.04 to 0.6; 0.06 to 0.55; 0.08 to 0.5; 0.1 to 0.45; 0.15 to 0.65; 0.02 to 0.6; 0.02 to 0.45; or 0.1 to 0.3.

In these or other embodiments, the polymers show an improvement in their degradation-versus-time profile versus a benchmark polymer. In these or other embodiments, the improvement is greater than 1, 5, 10, 15, 20, 25, 40, 50, 60, 70, 80, 90, 100%, 200%, 300%, 400%, 500%, 600%, 700%, 800%, 900%, or 1000%.

In other embodiments, invention polymers comprise a mixture of d,l-PLA with l-PLA. Some of these or other embodiments choose the d,l-PLA to have a molecular weight of 80,000-600,000, a glass transition temperature (Tg) of 50-55° C., or both. These or other embodiments mix in oligomeric d,l-PLA; some of these oligomers have an average molecular weight of 1000 to 50,000.

In these or other embodiments, invention polymers comprise a material mixed with a di-lactide monomer or d,l-PLA oligomers. In these or other embodiments, polyethylene glycol can be added. Sometimes the polyethylene glycol is selected from samples with a molecular weight of 1000 to 50,000. In these or other embodiments, the polymeric composition comprises PEG-PLA di-block or tri-block copolymers. I some cases, the polymer may degrade faster initially and then slow down over time.

In some embodiments, invention polymers are used as coatings on medical devices. In some embodiments, invention medical devices are constructed predominately out of invention polymers.

### BRIEF DESCRIPTION OF THE FIGURES

FIG. 1 is a plot showing degradation of a polymer versus time.

### DETAILED DESCRIPTION

The following definitions apply:

“Biologically degradable,” “biologically erodable,” “bioabsorbable,” and “bioresorbable” coatings or polymers mean those coatings or polymers that can completely degrade or erode when exposed to bodily fluids such as blood and that the body gradually resorbs, absorbs, or eliminates. The processes of breaking down, absorbing and eliminating the coating or polymer occurs by hydrolysis, metabolic processes, enzymatic processes, bulk or surface degradation, etc.

For purposes of this disclosure “biologically degradable,” “biologically erodable,” “bioabsorbable,” and “bioresorbable” are sometimes used interchangeably.

“Biologically degradable,” “biologically erodable,” “bioabsorbable,” or “bioresorbable” stent coatings or polymers mean those coating that, after the degradation, erosion, absorption, or resorption process finishes, no coating remains on the stent. “Degradable,” “biodegradable,” or “biologically degradable” broadly include biologically degradable, biologically erodable, bioabsorbable, or bioresorbable coatings or polymers.

“Biodegradability,” “bioerodability,” “bioabsorbability,” and “bioresorbability” are those properties of the coating or polymer that make the coating or polymer biologically degradable, biologically erodable, or biologically absorbable, or biologically resorbable.

“Bulk degradation” and “bulk-degrading” refer to degradation processes with several hallmarks. First, the water penetration rate into the polymeric body of the stent or coating is much faster than the polymer hydrolysis or mass loss rate. Next, hydrolysis-induced reduction of the polymer molecular weight occurs throughout the polymeric stent body or stent coating. Certain spatial variations in hydrolysis rate due to a buildup of acidic degradation products within the polymeric body can occur and are termed the autocatalytic effect. The acidic degradation products themselves catalyze further polymer hydrolysis. The mass-loss phase typically occurs later in a bulk degradation process, after the molecular weight of the polymeric body has fallen. As a result, in an idealized bulk-degrading case, the stent or coating mass loss, occurs throughout the entire stent or the coating rather than just at the surface.

“Polydispersity” is the distribution of the molecular weight of a polymer, since every polymer has molecules with a variety of chain lengths. One way of expressing polydispersity is with a polydispersity index (PI). PI equals the weight-averaged molecular weight of a polymer sample (M_{w}) divided by the number-averaged molecular weight of the same sample (Mₙ). “Weight-averaged molecular weight” (M_{w}) is the molecular weight of polymer sample calculated as
M_{w}=Σ(M₁²Nᵢ)/Σ(MᵢNᵢ),
where Mᵢ is the molecular weight of the macromolecule of the “i” fraction and Nᵢ is a number of macromolecules in the “i” fraction. “Number-averaged molecular weight” (Mₙ) is the molecular weight of a polymer sample calculated as
Mₙ=Σ(MᵢNᵢ)/Σ(Nᵢ),
where Mᵢ and Nᵢ are as defined above.

For most polymers, M_{w}≧Mₙ, and consequently PI≧1.0. As the polymer's molecular weight distribution becomes narrower, the PI value approaches 1.0. For a theoretically monodisperse polymer, M_{w}=Mₙ; and PI=1.0.

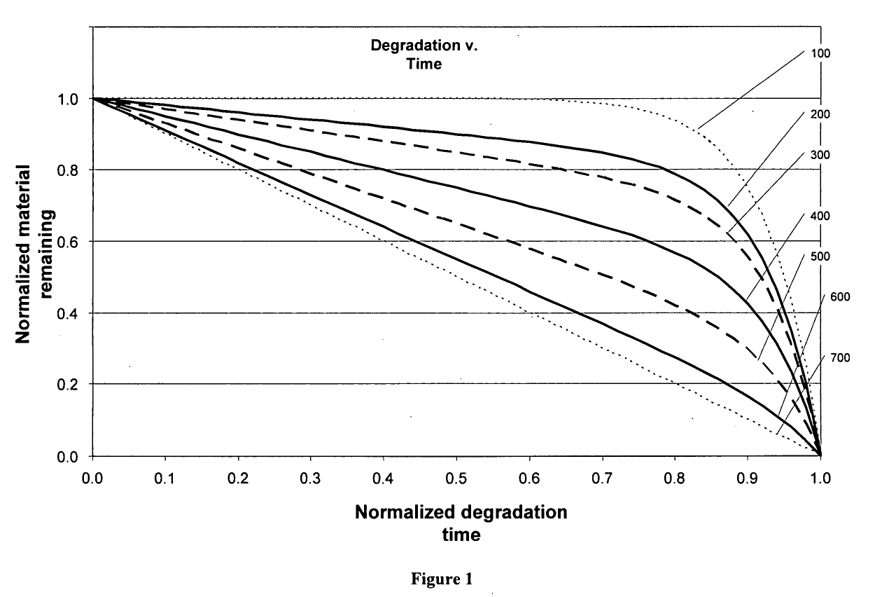

Most biodegradable materials fall on a continuum between completely bulk-degrading and completely surface-degrading. An idealized bulk-degrading material will exhibit degradation of its mass, mechanical properties, and molecular weight versus time behavior that can be described by the graph of FIG. 1. Once the material is implanted, for an initial time, the curve is flat. During this time, water diffuses into the material (which occurs faster than the hydrolysis rate of the material). Once the material has been exposed to water long enough, it begins to degrade. But by then, molecules throughout the material degrade. This gives rise to the term bulk-degrading material or polymer. And it explains why the final part of the curve shows an increased degradation rate vis-à-vis a surface-degrading material. The whole of the material is primed for disassociation not just a relatively thin layer as with surface-degrading materials. Generally, as alluded to above, an idealized surface-degrading material degrades completely from the surface inward. This occurs because the diffusion rate into the material is much slower than the degradation rate. And it means that, before water has time to diffuse into the bulk of the material, water has dissolved the surface of the material. Therefore, bulk degradation does not occur in an idealized, surface-degrading material because the bulk of the molecules of the material do not contact water until they reside at the surface. Overall, surface degradation is more or less constant for surface-degrading materials.

The above description describes idealized bulk-degrading and surface-degrading materials. Alternatively, idealized bulk degrading behavior could be called variable-rate degrading behavior. That is, the rate of mass loss or other property reduction that depends on mass loss is slower initially, because there is an induction period in which hydrolysis is occurring through-out the polymeric material. But the hydrolysis predominately causes the polymer chains to shorten rather than become soluble. During this time, hydrolysis is generating acid within the polymeric material. Since hydrolysis is acid catalyzed, as the reaction progresses more catalyst is created, thereby increasing the hydrolysis or degradation rate. This synergistic activity is called the autocatalytic effect. Accelerated degradation with time caused by the autocatalytic effect is thought to cause a major impact on the tissue surrounding the medical device and is thought to lead to inflammation and other deleterious in vivo effects.

Similarly, surface-degrading kinetic behavior could be called constant rate degrading behavior. A material showing this kinetics has a rate of degradation that remains substantially constant throughout the degradation process.

The kinetic behavior observed for most biodegradable polymers falls between these ideals. Thus, any given biodegradable material has inherent biodegradation kinetics that can be modeled using an equation that looks like the sum of a variable-rate degrading component and a constant-rate degrading component regardless of the actual physical process the polymer degrades by.

In one invention embodiment, a material is modified so that its overall biodegradation behavior becomes more surface-degrading like, i.e. the surface-degrading-component contribution to the overall degradation characteristics goes up.

A variety of modifications can be used. One modification comprises layering a faster bulk-degrading material over a slower bulk-degrading material. Another modification comprises making the material more porous. This increases the surface area versus the bulk volume allowing surface degradation to contribute more to the overall degradation. The material can be porous by nature or as implanted or can comprise a porosigen that rapidly dissolves upon contacting the in vivo environment leaving pores behind. A third modification comprises making the material more hydrophilic. A fourth modification comprises changing the material's polymerization conditions such that the material has a wider or flatter molecular weight distribution. A fifth modification comprises mixing two or more materials with narrow, but different, molecular weight distributions. A sixth modification comprises using a lower molecular weight material. A seventh modification comprises adding a pH buffer material to interfere with or shut down the autocatalytic effect. An eight modification comprises decreasing “h”, as described below or otherwise raising the proportion of surface area to volume. Some invention embodiments use these modifications or other modifications as are known to those of ordinary skill is the art. Some embodiments use a combination of these modifications with each other or with other modifications known to those of ordinary skill in the art. Some embodiments use a combination of art-known modifications to the materials. Also, some embodiments specifically exclude any one of or any combination of these modifications, and some embodiments specifically exclude any one of or any combination of other art-known modifications to bioerodible materials.

Homogeneous versus heterogeneous degradation is determined by the following parameter:

$$\frac{D}{{h}^{2}}$$

where D represents the diffusivity of the predominante acidic degradation product and h represents the thickness of the absorbable construct.

As the thickness goes up, the overall value of the parameter drops, which indicates a more heterogeneous and less constant degradation process. Conversely, as the thickness goes down, the parameter increases, which indicates greater homogeneous character in the degradation process. Small enough thickness of the absorbable construct allows the acidic degradation products to diffuse out or the object rather than build up within the object and contribute to or cause the autocatalytic effect.

For surface degradation control, the linear rate constant K_{d} and Surface Area/Volume ratio (which is proportional to “h” for a rectangular object) are both important.

“h” controls the absorption in two ways. Low h favors homogeneous degradation by preventing the build up of generated lactic acid. Also, low h indicates that the ratio of the surface area to the volume is such that surface degradation predominates for a low h system.

Returning to the case of idealized bulk-degrading materials or polymers, the mass loss at time=0, tₒ, is 0%. The mass loss is 100% when the material has completely hydrolyzed. This is called the final time, t_{f}. The same definitional system can be set up for surface-degrading polymers or materials. Of course, for surface-degrading polymers or materials, at 0.5t_{f}, half of the material should have decomposed.

FIG. 1 shows how various parameters of bioerodable, medical-device materials decrease versus time in curves 100-700. Curve 100 represents an idealized, bulk-degrading material; Curve 700 represents an idealized, surface-degrading material.

These curves represent how much mass, molecular weight, or strength is lost in a bioerodable material over time. For real systems, these curves can be measured in vitro under conditions mimicking in vivo conditions including the rapidity in which materials desorbed from the medical device are carried away from the device. Also, the curves can be measured in vivo.

As discussed above, bioerodable materials have inherent properties that cause the material to exhibit a particular degradation versus time profile, which can be plotted similar to curves 100-700.

The idealized bulk-degrading polymer is arbitrarily assigned the point at which it begins to decompose in FIG. 1. Curves 200-600 are drawn for reference and represent the expected behavior of polymers or materials that biodegrade through processes in which the kinetics are a combination of bulk degradation and surface degradation kinetics. These curves represent idealized polymers that show a combination of bulk-eroding and surface-eroding kinetics. These idealized curves do not represent a physical picture of the degradation process, especially at degradation levels past 90%, but instead represent a way of parameterizing the degradation curve space.

As can be seen from FIG. 1, the idealized surface-degrading material has a degradation versus time curve that has a constant slope of −1. The idealized bulk-degrading material has a similar curve with an average slope =−1, but in this case the slope is not constant. Initially, the slope is greater than −1, but near the end of the degradation, the slope becomes considerably less than −1. Consequently, when the degrading quantity is mass, correspondingly less material and degradation products release near the beginning of the process, and correspondingly more material and degradation products release toward the process's end. Not shown on FIG. 1, but easily envisioned, are similar curves in which the initial slope is greater than −1, but near the latter or final stages of degradation, the slope rise above −1. This non-constant behavior is believed to fuel local inflammatory processes, as well as other undesirable processes.

The behavior of real systems is frequently more complex than that shown in FIG. 1. For instance, some polymers may initially show a typical bulk degradation rate until a portion, even a majority, of the material has degraded. Then further degradation may appear to cease for long periods, such as days or weeks (in vitro or in vivo). For those systems, total degradation time and amount may have to be calculated somewhat differently. More specifically, consider a hypothetical system in which 85% of the material degrades over 2 months following typical bulk degradation kinetics. After this degradation, the kinetics show a constant degradation rate until the material has lost 95% of its initial mass after 4 months. One of ordinary skill in the art would treat these two regions as distinct. For such a system, t_{f} is taken to have occurred at the 2 month point and 85% mass loss is taken as the total mass loss.

Invention processes are targeted at making particular biodegrading materials or systems show degradation kinetics more like the kinetics of surface degrading systems whether the degradation process is changed to a surface degradation or whether the degradation rates become more constant.

One way of determining how closely the degradation kinetics of a real sample match those of prototypical system showing 100% surface degradation kinetics is by comparing the measured slope of the degradation curve with that of the prototypical system. The slope of the degradation curve of such a prototypical system is −1.

For invention polymers, the following equation holds true:

$$K ≡ \vert slope of prototypical system - actual slope of polymer \vert \leq A$$

$$\begin{matrix}where A = 0.01 , 0.02 , 0.04 , 0.06 , 0.08 , 0.01 , 0.15 , 0.2 , 0.25 , \\ 0.3 , 0.35 , 0.4 , 0.45 , 0.5 , 0.55 , 0.6 , 0.65 , or 0.7 .\end{matrix}$$

In these or other embodiments, K is from 0.01 to 0.7; 0.02 to 0.65; 0.04 to 0.6; 0.06 to 0.55; 0.08 to 0.5; 0.1 to 0.45; 0.15 to 0.65; 0.02 to 0.6; 0.02 to 0.45; or 0.1 to 0.3.

As discussed above, FIG. 1's ideal curves do not attempt to portray the vagaries that a degradation versus time curve can sometimes show during an initial time or a final time period. To account for these variations, the slope is calculated by measuring the average slope from 10% degradation to 50% degradation (referred to as Slope A); from 10% degradation to 40% degradation (Slope B); from 10% degradation to 30% degradation (Slope C); from 10% degradation to 20% degradation (Slope D); or from 20% degradation to 30% degradation (Slope E). This avoids the initially non-ideal behavior sometimes demonstrated by degradation processes. These behaviors are well known to those of ordinary skill in the art.

For purposes of this disclosure, the notation K_{A} means the absolute value of [the slope of the prototypical, surface-eroding system measured at Slope A minus the actual slope of the polymer measured at Slope A]. Likewise, the notation K_{E} means the absolute value of [the slope of the prototypical, surface-eroding system measured at Slope E minus the actual slope of the polymer measured at Slope E].

For purposes of this disclosure, a benchmark material is a conventional bioerodable material that has not been prepared using inventive modifications. Of course, the degradation-versus-time profile for a benchmark material (“benchmark degradation curve”) can be determined and plotted. Invention materials or polymers are similar to benchmark materials except that they have been treated with invention modifications such that their degradation-versus-time profile is improved; that is, it lies substantially closer to a constant-rate degrading material than does its corresponding benchmark material. In some embodiments, a degradation curve is said to be improved when the degradation curve of the polymer has a lower K value than that of the benchmark material. In some embodiments, the improvement is greater than 1%, 5%, 10%, 15%, 20%, 25%, 40%, 50%, 60%, 70%, 80%, 90%, 100%, 200%, 300%, 400%, 500%, 600%, 700%, 800%, 900%, or 1000%.

For invention embodiments in which the inventive modification causes a broader molecular weight distribution either through manipulation of the polymerization conditions or through mixing several components with different molecular weight distribution, some embodiments comprise, biologically degradable, erodable, absorbable or resorbable polymers, or blends thereof, having an improved degradation curve can be used to fabricate a stent. The polymers or blends can have PI between about 2.2 and about 20, about 2.5 and about 15, or about 2.8 and about 12.5

A variety of methods yield the polymer or the blend having a desired PI. One method includes physically blending two or more fractions of a polymer, where the fractions have differing molecular weights. Fractions of the same polymer or of different polymers can be used for blending. Examples of useful polymers that can be used for preparing the blends include poly(D,L-lactic acid), poly(D-lactic acid), poly(L-lactic acid), poly(L-lactide-co-D,L-lactide), poly(glycolide), poly(D,L-lactide-co-glycolide), poly(caprolactone), poly(L-lactide-co-caprolactone), poly(glycolide-co-caprolactone), poly(3-hydroxybutyrate), poly(4-hydroxybutyrate), poly(3-hydroxyvalerate), poly(hydroxybutyrate-co-valerate), poly(dioxanone), poly(trimethylene carbonate), poly(D,L-lactide-co-trimethylene carbonate), poly(ester amides), poly(iminocarbonates), poly(carbonates) derived from tyrosine, poly(arylates) derived from tyrosine, or any combination thereof.

Blending between 2 and 10 fractions, e.g. 3 fractions can yield a suitable poly disperse polymer. The difference between the MW of the fractions can be described by the spread between the highest and the lowest fractions. For Mₙ, this spread can be defined as the ratio of the highest Mₙ to the lowest Mₙ. The blends can have a ratio of between about 5 and about 100, such as between 9 and about 55. In describing the quantities of the fractions, it is easiest to use a weight fraction. In the case of a two fraction system, the low MW fraction will have a weight fraction in the range of 0.1 to 0.9, more preferably in the range of 0.3 to 0.7.

Alternatively, a single polymer having the desired PI value can be synthetically prepared. To have a high PI value described above, the polymer can have a broad molecular weight distribution. Various synthetic techniques can be used to this end. For example, one of poly(lactic acids), i.e., poly(D,L-lactic acid), poly(D-lactic acid) or poly(L-lactic acid, having a high PI value, can be synthesized.

Poly(lactic acid) has the general formula H—[O—CH(CH₃)—C(O)]ₙ—OH. This polymer can be obtained by a condensation polymerization of lactic acid itself. However, this tends to result in low molecular weight polymer. Hence, the ring opening polymerization, using the cyclic lactides is a versatile technique that can reach high molecular weights. Ring-opening polymerization is demonstrated schematically by reaction (I):

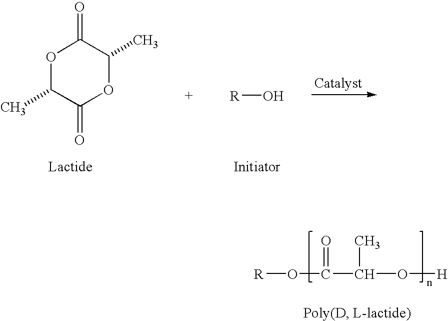

To obtain poly(D,L-lactide) having a typical PI, reaction (I) can be carried out in the presence of an initiator, the initiator being a low molecular weight alcohol (e.g. ethanol to dodecanol) and useful catalysts being stannous octanoate (tin (II) 2-ethylhexanoate) or zinc metal. Useful monomer to catalyst ratios lie in the range of 10 to 10,000 (w/w). The ratio of initiator to monomer depends on the degree of polymerization desired. The polymerization can be conducted in the bulk by heating from 125-160° C. for 2-48 hours. Several different samples are prepared with different monomer to initiator ratios, which yields samples with different average molecular weight. When these samples are mixed, they result in a polymer with a more desirable PI—one that is broader.

Another way to obtain poly(D,L-lactide) having a desirable PI, is to run reaction (I) out in the presence of a polydisperse initiator, and useful catalysts being stannous octanoate (tin (II) 2-ethylhexanoate) or zinc metal. Useful monomer to catalyst ratios lie in the range of 10 to 10,000 (w/w). The ratio of initiator to monomer depends on the degree of polymerization desired. The polymerization can be conducted in the bulk by heating from 125-160° C. for 2-48 hours. Several different samples are prepared with different monomer to initiator ratios, which yields samples with different average molecular weight. When these samples are mixed, they result in a polymer with a more desirable PI—one that is broader.

This methodology can be extended the other useful polymers, as is known to those of ordinary skill in the art. Generally, the polymerization reaction is run in the presence of an amount of very low molecular weight polymer that itself is polymerizable in the system. As monomer polymerizes, some monomer reacts with each other as is typical. But some monomer reacts with the molecules from the very low molecular weight polymer. Therefore, the overall polymerization product contains polymer chains that began at different lengths at their starting points, which provides a broader molecular weight distribution and higher PI.

In alternative embodiments, low molecular weight d,l-PLA can be blended into l-PLA.

Low crystallinity l-PLA-based absorbable polymers have several advantages:
i) low crystallinity is believed to trigger fewer or less severe adverse chronic problems in vivo;
ii) low crystallinity should result in faster degradation in vivo;
iii) low crystallinity and relatively low Tg of d,l-PL will allow-PLA mixed with d,l-PLA to exhibit simple, less severe thermal processing sequences during crimping, sheathing, etc., which will lessen thermal damage to the drug;
iv) low crystallinity leads to a higher strain-to-failure parameter; and
v) low crystallinity will give a ductile as opposed to a brittle failure mechanism.

The d,l-PLA polymer has a weight average molecular weight of 80K-600K, in some embodiments. In these or other embodiments, the d,l-PLA polymer is mixed with L-PLA at a weight-to-weight ratio, d,l-PLA to l-PLA of 10%-80%.

In some embodiments, oligomeric d,l-PLA with a weight range molecular weight of 1000-5000 will be mixed into the l-PLA. In some of these embodiments, the oligomers act as a plasticizer. In any of the embodiments described above or in other embodiments, —COOH terminated d,l-PLA can be added to modulate a faster absorption rate.

In any of the embodiments described above or in any other embodiments, di-lactide monomer and/or oligomeric d,l-PLA can also be added. In some of these embodiments, these materials will act as a plasticizer. In some embodiments, these materials also act to modulate a faster absorption rate.

Additionally, in some of the embodiments described above or in others, polyethylene glycol can be blended in as a non-fouling, low Tg plasticizer. In some embodiments containing polyethylene glycol, the weight average molecular weight is from 1,000-50,000.

In some of the embodiments described above or in others, PEG-PLA di- and tri-block copolymers can be added as a non-fouling, low Tg component.

In some embodiments described above or in other embodiments, having a decreased degradation rate will allow using a polymer mixture with an overall molecular weight higher than otherwise desirable, without having a long degradation time. This allows choosing a polymer mixture with better mechanical properties without causing the material to remain longer.

These invention polymer mixtures are useful for constructing bioabsorbable medical devices and for bioabsorbable medical device coatings. The medical device may or may not include drugs within the invention polymer bulk or within the invention polymer coating.

To manufacture a stent, several standard polymer processing techniques can be used. For example, the multiple fractions of polymer can be blended on a twin screw extruder, or other compounding machine, and then can be pelletized. Alternatively, the blends are extruded to form a fiber of the strut dimensions. These oriented fibers are cut and then bent into a circular shape under the action of heat. Spot heating by hot air, laser, or thermal contact can join the ends. These hoops are then molded into a meandered, crown shape by thermal stamping. The resulting crown-shaped hoops are thermally joined together at one or more points to form a stent. In an alternate approach, the polymer blend is extruded into a hollow tube with a diameter matching the stent OD and wall thickness matching the desired strut thickness. A stent is cut by laser machining. Drugs can be incorporated in several ways. If the drug has the requisite thermal stability, then it can be blended with the polymer fractions in the compounding machine. This places the drug in the entire body of the absorbable stent. In cases where this is not possible, the drug can be applied to the completed stent by a coating operation. Using a solvent, the drug is combined with the same, or different, absorbable polymer blend in solution. This coating is then applied by dip, spraying, casting, or direct application to the surface of the stent. This results in an absorbable stent with a coating of absorbable polymer containing the drug. In the case where the objective is only to have a bioabsorbable coating with a linear rate of mass loss, such a coating system can be applied on top of a permanent stent, such as those composed of metal. Polymer polydispersity and molecular weight selection in the coating, will give a linear rate of mass loss for just the coating.

According to other embodiments of the present invention, biologically degradable erodable, absorbable or resorbable polymers having a constant in vivo rate of degradation can be also used to fabricate a stent or stent coating. Any polymer described above, or any blend thereof, can be used.

The stent or stent coating can be a multi-layer structure that can include any of the following three layers or combination thereof:
a primer layer;
a drug-polymer layer (also referred to as “reservoir” or “reservoir layer”) and/or a polymer free drug layer; and/or
a topcoat layer.

Each layer of the stent or stent coating can be formed on the stent by dissolving the polymer or a blend of polymers in a solvent, or a mixture of solvents, and applying the resulting polymer solution on the stent by spraying or immersing the stent in the solution. After the solution has been applied onto the stent, the coating is dried by allowing the solvent to evaporate. The process of drying can be accelerated if the drying is conducted at an elevated temperature.

To incorporate a drug into the reservoir layer, the drug can be combined with the polymer solution that is applied onto the stent or stent as described above. Alternatively, a polymer-free reservoir can be made. To fabricate a polymer free reservoir, the drug can be dissolved in a suitable solvent or mixture of solvents, and the resulting drug solution can be applied on the stent by spraying or immersing the stent in the drug solution.

Instead of introducing the drug as a solution, the drug can be introduced as a colloid system, such as a suspension in an appropriate solvent phase. To make the suspension, the drug can be dispersed in the solvent phase using conventional techniques used in colloid chemistry. Depending on a variety of factors, e.g., the nature of the drug, those having ordinary skill in the art can select the solvent to form the solvent phase of the suspension, as well as the quantity of the drug to be dispersed in the solvent phase. The suspension can be mixed with a polymer solution and the mixture can be applied on the stent or stent as described above. Alternatively, the drug suspension can be applied on the stent or stent without being mixed with the polymer solution.

The drug-polymer layer can be applied directly onto at least a part of the stent or stent surface to serve as a reservoir for at least one active agent or a drug which is incorporated into the reservoir layer. The optional primer layer can be applied between the stent or stent and the reservoir to improve the adhesion of the drug-polymer layer to the stent or stent. The topcoat layer, if used, can be applied over at least a portion of the reservoir serves as a rate limiting membrane, which helps to control the rate of release of the drug. In one embodiment, the topcoat layer can be essentially free from any active agents or drugs.

The process of the release of the drug from a coating having the topcoat layer includes at least two steps. First, the drug is absorbed by the polymer of the topcoat layer on the reservoir/topcoat layer interface. Next, the drug diffuses through the topcoat layer, using void spaces between the macromolecules of the topcoat layer polymer as pathways for migration, and desorbs from the outer surface. At this point, the drug is released into the blood stream.

In one embodiment, any or all of the layers of the stent or stent coating, can be made of a biologically degradable, erodable, absorbable, and/or resorbable polymer. In another embodiment, the outermost layer of the coating can be limited to such a polymer.

To illustrate in more detail, in the stent coating having all three layers described above (i.e., the primer, the reservoir, and the topcoat layer), the outermost layer of the stent coating is the topcoat layer, which is made of a polymer that is biologically degradable, erodable, absorbable, and/or resorbable. In this case, optionally, the remaining layers (i.e., the primer and the reservoir) can be also fabricated of a biologically degradable polymer; and the polymer can be the same or different in each layer.

If the topcoat layer is not used, the stent coating can have two layers, the primer and the reservoir. The reservoir in this case is the outermost layer of the stent coating and is made of a biologically degradable polymer. Optionally, the primer can be also fabricated of a biologically degradable polymer, which can be the same or different in the reservoir and in the primer.

The biological degradation, erosion, absorption and/or resorption of a biologically degradable, erodable, absorbable or resorbable polymer are expected to cause the increase of the release rate of the drug due to the gradual disappearance of the polymer that forms the reservoir or the topcoat layer, or both.

Any layer of the stent or stent coating can contain any amount of the bioabsorbable polymer(s) described above, or a blend of more than one of such polymers. If less than 100% of the layer is made of the bioabsorbable polymer(s) described above, alternative polymers can compose the balance. Examples of the alternative polymers that can be used include polyacrylates, such as poly(butyl methacrylate), poly(ethyl methacrylate), poly(ethyl methacrylate-co-butyl methacrylate), poly(acrylonitrile), poly(ethylene-co-methyl methacrylate), poly(acrylonitrile-co-styrene), and poly(cyanoacrylates); fluorinated polymers and/or copolymers, such as poly(vinylidene fluoride) and poly(vinylidene fluoride-co-hexafluoro propene); poly(N-vinyl pyrrolidone); polyorthoester; polyanhydride; poly(glycolic acid-co-trimethylene carbonate); polyphosphoester; polyphosphoester urethane; poly(amino acids); co-poly(etheresters); polyalkylene oxalates; polyphosphazenes; biomolecules, such as fibrin, fibrinogen, cellulose, starch, collagen and hyaluronic acid; polyurethanes; silicones; polyesters; polyolefins; polyisobutylene and ethylene-alphaolefin copolymers; vinyl halide polymers and copolymers, such as polyvinyl chloride; polyvinyl ethers, such as polyvinyl methyl ether; polyvinylidene chloride; polyvinyl ketones; polyvinyl aromatics such as polystyrene; polyvinyl esters such as polyvinyl acetate; copolymers of vinyl monomers with each other and olefins, e.g., poly(ethylene-co-vinyl alcohol) (EVAL); ABS resins; and poly(ethylene-co-vinyl acetate); polyamides such as Nylon 66 and polycaprolactam; alkyd resins; polycarbonates; polyoxymethylenes; polyimides; polyethers, epoxy resins; polyurethanes; rayon; rayon-triacetate; cellulose; cellulose acetate; cellulose butyrate; cellulose acetate butyrate; cellophane; cellulose nitrate; cellulose propionate; cellulose ethers; and carboxymethyl cellulose. Some embodiments specifically exclude any one or any combination of the alternative polymers listed above from inclusion with invention polymers.

Representative examples of some solvents suitable for making the stent or stent coatings include N,N-dimethylacetamide (DMAC), N,N-dimethylformamide (DMF), tethrahydrofurane (THF), cyclohexanone, xylene, toluene, acetone, i-propanol, methyl ethyl ketone, propylene glycol monomethyl ether, methyl butyl ketone, ethyl acetate, n-butyl acetate, and dioxane. Some solvent mixtures can be used as well. Representative examples of the mixtures include:
DMAC and methanol (e.g., a 50:50 by mass mixture);
water, i-propanol, and DMAC (e.g., a 10:3:87 by mass mixture);
i-propanol, and DMAC (e.g., 80:20, 50:50, or 20:80 by mass mixtures);
acetone and cyclohexanone (e.g., 80:20, 50:50, or 20:80 by mass mixtures);
acetone and xylene (e.g. a 50:50 by mass mixture);
acetone, FLUX REMOVER AMS, and xylene (e.g., a 10:50:40 by mass mixture); and 1,1,2-trichloroethane and chloroform (e.g., an 80:20 by mass mixture).

FLUX REMOVER AMS is trade name of a solvent manufactured by Tech Spray, Inc. of Amarillo, Tex. comprising about 93.7% of a mixture of 3,3-dichloro-1,1,1,2,2-pentafluoropropane and 1,3-dichloro-1,1,2,2,3-pentafluoropropane, and the balance of methanol, with trace amounts of nitromethane. Those having ordinary skill in the art will select the solvent or a mixture of solvents suitable for a particular polymer being dissolved.

Therapeutic substances that can be used in the reservoir layer include any substance capable of exerting a therapeutic, prophylactic, or diagnostic effect in a patient.

Some embodiments add conventional drugs, such as small, hydrophobic drugs, to invention polymers (as discussed in any of the embodiments, above), making them biostable, drug systems. Some embodiments graft-on conventional drugs or mix conventional drugs with invention polymers. Invention polymers can serve as base or topcoat layers for biobeneficial polymer layers.

The selected drugs can inhibit vascular, smooth muscle cell activity. More specifically, the drug activity can aim at inhibiting abnormal or inappropriate migration or proliferation of smooth muscle cells to prevent, inhibit, reduce, or treat restenosis. The drug can also include any substance capable of exerting a therapeutic or prophylactic effect in the practice of the present invention. Examples of such active agents include antiproliferative, antineoplastic, antiinflammatory, antiplatelet, anticoagulant, antifibrin, antithrombin, antimitotic, antibiotic, and antioxidant substances, as well as their combinations, and any prodrugs, metabolites, analogs, congeners, derivatives, salts and their combinations.

An example of an antiproliferative substance is actinomycin D, or derivatives and analogs thereof (manufactured by Sigma-Aldrich 1001 West Saint Paul Avenue, Milwaukee, Wis. 53233; or COSMEGEN available from Merck). Synonyms of actinomycin D include dactinomycin, actinomycin IV, actinomycin I1, actinomycin X1, and actinomycin C1. Examples of antineoplastics include paclitaxel and docetaxel. Examples of antiplatelets, anticoagulants, antifibrins, and antithrombins include aspirin, sodium heparin, low molecular weight heparin, hirudin, argatroban, forskolin, vapiprost, prostacyclin and prostacyclin analogs, dextran, D-phepro-arg-chloromethylketone (synthetic antithrombin), dipyridamole, glycoprotein IIb/IIa platelet membrane receptor antagonist, recombinant hirudin, thrombin inhibitor (available from Biogen), and 7E-3B® (an antiplatelet drug from Centocor). Examples of antimitotic agents include methotrexate, azathioprine, vincristine, vinblastine, fluorouracil, adriamycin, and mutamycin. Examples of cytostatic or antiproliferative agents include angiopeptin (a somatostatin analog from Ibsen), angiotensin converting enzyme inhibitors such as CAPTOPRIL (available from Squibb), CILAZAPRIL (available from Hoffman-LaRoche), or LISINOPRIL (available from Merck & Co., Whitehouse Station, N.J.), calcium channel blockers (such as Nifedipine), colchicine, fibroblast growth factor (FGF) antagonists, histamine antagonist, LOVASTATIN (an inhibitor of HMG-CoA reductase, a cholesterol lowering drug from Merck & Co.), monoclonal antibodies (such as PDGF receptors), nitroprusside, phosphodiesterase inhibitors, prostaglandin inhibitor (available from Glazo), Seramin (a PDGF antagonist), serotonin blockers, thioprotease inhibitors, triazolopyrimidine (a PDGF antagonist), and nitric oxide. Other useful drugs may include alpha-interferon, genetically engineered epithelial cells, dexamethasone, estradiol, clobetasol propionate, cisplatin, insulin sensitizers, receptor tyrosine kinase inhibitors, and carboplatin. Exposure of the composition to the drug should not adversely alter the drug's composition or characteristic. Accordingly, drug containing embodiments choose drugs that are compatible with the composition. Rapamycin is a suitable drug. Additionally, methyl rapamycin (ABT-578), everolimus, 40-O-(2-hydroxy)ethyl-rapamycin, or functional analogs or structural derivatives thereof, is suitable, as well. Examples of analogs or derivatives of 40-O-(2-hydroxy)ethyl-rapamycin include, among others, 40-O-(3-hydroxy)propyl-rapamycin and 40-O-2-(2-hydroxy)ethoxyethyl-rapamycin. Those of ordinary skill in the art know of various methods and coatings for advantageously controlling the release rate of drugs, such as 40-O-(2-hydroxy)ethyl-rapamycin.

Some embodiments choose the drug such that it does not contain at least one of or any combination of antiproliferative, antineoplastic, antiinflammatory, antiplatelet, anticoagulant, antifibrin, antithrombin, antimitotic, antibiotic, or antioxidant substances, or any prodrugs, metabolites, analogs, congeners, derivatives, salts or their combinations.

Some invention embodiments choose the drug such that it does not contain at least one of or any combination of actinomycin D, derivatives and analogs of Actinomycin D, dactinomycin, actinomycin IV, actinomycin I1, actinomycin X1, actinomycin C1, paclitaxel, docetaxel, aspirin, sodium heparin, low molecular weight heparin, hirudin, argatroban, forskolin, vapiprost, prostacyclin, prostacyclin analogs, dextran, D-phe-pro-arg-chloromethylketone (synthetic antithrombin), dipyridamole, glycoprotein IIb/IIIa platelet membrane receptor antagonist, recombinant hirudin, thrombin inhibitor and 7E-3B, methotrexate, azathioprine, vincristine, vinblastine, fluorouracil, adriamycin, mutamycin, angiopeptin, angiotensin converting enzyme inhibitors, CAPTOPRIL, CILAZAPRIL, or LISINOPRIL, calcium channel blockers, Nifedipine, colchicine, fibroblast growth factor (FGF) antagonists, histamine antagonist, LOVASTATIN, monoclonal antibodies, PDGF receptors, nitroprusside, phosphodiesterase inhibitors, prostaglandin inhibitor, Seramin, PDGF antagonists, serotonin blockers, thioprotease inhibitors, triazolopyrimidine, nitric oxide, alpha-interferon, genetically engineered epithelial cells, dexamethasone, estradiol, clobetasol propionate, cisplatin, insulin sensitizers, receptor tyrosine kinase inhibitors, carboplatin, Rapamycin, methyl rapamycin (ABT-578), 40-O-(2-hydroxy)ethyl-rapamycin, or a functional analogs of 40-O-(2-hydroxy)ethyl-rapamycin, structural derivative of 40-O-(2-hydroxy)ethyl-rapamycin, 40-O-(3-hydroxy)propyl-rapamycin, and 40-O-2-(2-hydroxy)ethoxyethyl-rapamycin, or any prodrugs, metabolites, analogs, congeners, derivatives, salts or their combinations.

Some invention embodiments comprise a drug or drug combination, and some require a drug or combination of drugs. Of the drugs specifically listed above, some invention embodiments exclude a single or any combination of these drugs.

The coatings and methods of the present invention have been described with reference to a stent, such as a balloon expandable or self-expanding stent. The use of these materials is not limited to stents, however, and the coating can also be used with a variety of other medical devices. Examples of the implantable medical device, that can be used in conjunction with the embodiments of this invention include stent-grafts, grafts (e.g., aortic grafts), artificial heart valves, cerebrospinal fluid shunts, pacemaker electrodes, axius coronary shunts and endocardial leads (e.g., FINELINE and ENDOTAK, available from Guidant Corporation). The underlying structure of the device can be of virtually any design. The device can be made of a metallic material or an alloy such as, but not limited to, cobalt-chromium alloys (e.g., ELGILOY), stainless steel (316L), “MP35N,” “MP20N,” ELASTINITE (Nitinol), tantalum, tantalum-based alloys, nickel-titanium alloy, platinum, platinum-based alloys such as, e.g., platinum-iridium alloy, iridium, gold, magnesium, titanium, titanium-based alloys, zirconium-based alloys, or combinations thereof. Devices made from bioabsorbable or biostable polymers can also be used with the embodiments of the present invention.

“MP35N” and “MP20N” are trade names for alloys of cobalt, nickel, chromium and molybdenum available from Standard Press Steel Co. of Jenkintown, Pa. “MP35N” consists of 35% cobalt, 35% nickel, 20% chromium, and 10% molybdenum. “MP20N” consists of 50% cobalt, 20% nickel, 20% chromium, and 10% molybdenum.

### EXAMPLES

The following examples are provided to further illustrate embodiments of the present invention.

### PROPHETIC EXAMPLES

### Example 1

### Polymer Blending

High molecular weight poly(L-lactide), M_{w}=450K, PI=1.80 is combined with low molecular weight poly(L-lactide), M_{w}=10K, PI=1.34. Into a tumble blender is placed a 70/30 (w/w) mix of a high and a low molecular weight poly(L-lactide). After blending, the pellets are fed into a twin screw extruder that produces an extruded strand that is pelletized. For the blend, the M_{w} is approximately 177 k, with a PI of 7.6.

### Example 2

### Stent Construction with a Polymer Blend

Using the blended pellets of Example 1, a tube is extruded with an outer diameter of 3 mm and a wall thickness of 175 microns. The stent is mounted onto a rigid mandrel and placed into a computer machine controlled laser cutter. Using an excimer laser, a stent is cut from the tube yielding a 14 mm long stent.

### Example 3

### Coating with the Blend of Example 1

A composition is prepared by mixing the following components:
2.0 mass % of the polymer of Example 1
1.0 mass % of everolimus
the balance, a 50/50 blend by weight of chloroform and 1,1,2-trichloroethane

The composition is applied onto the surface of the stent of Example 2. The coating is sprayed and dried to form a drug reservoir layer. A spray coater is used having a 0.014 round nozzle maintained at ambient temperature with a feed pressure 2.5 psi (0.17 atm) and an atomization pressure of about 15 psi (1.02 atm). Coating is applied at 20 ug per pass, in between which the stent is dried for 10 seconds in a flowing air stream at 50° C. Approximately 500 ug of wet coating is applied. The stents are baked at 60° C. for one hour, yielding a drug reservoir layer composed of approximately 450 ug of coating. No primer is necessary, as this coating fuses with the polymer of the underlying stent.

### Example 4

### Prophetic Synthesis of L-Lactide with Suitable PI

In this example, a conventional ring opening polymerization of L-lactide is performed using stannous octoate as a catalyst, and 1-hexanol as an initiator. In order to achieve a very broad MW distribution, the initiator is added as three aliquots, spaced out over time. This results in three different sets of growing polymer chains. A 2-necked, 50 ml flask equipped with stopcock, septum and stirbar was flame dried under vacuum, and purged with argon. Inside an argon filled glove box, L-lactide (50 gm, 0.347 mol) was placed with stannous octanoate (1.41 gm, 0.0347 mol). The reaction mixture was heated in an oil bath with stirring to 140° C. At time zero, 1′-hexanol is added (6.8 mg, 0.067 mmol) is added and the reaction allowed to proceed for 30 minutes. At this point, another aliquot of 1′-hexanol is added (17 mg, 0.167 mmol) and the reaction allowed to proceed another 30 minutes. A final aliquot of 1′-hexanol is added (0.22 gm, 2.16 mmol) and the reaction allowed to proceed for another 2 hours. The reaction mixture is poured into 500 ml of methanol, the precipitated polymer isolated, and dried under vacuum.

### Example 5

### Prophetic Stent Construction with the Polymer of Example 4

This example is analogous to example 2 only the polymer of example 4 is substituted or the polymer of example 1.

### Example 6

### Prophetic Coating with the Polymer of Example 4

A first composition is prepared by mixing the following components:
2.0 mass % of the polymer of example 4.
the balance, a 50/50 blend by weight of chloroform and 1,1,2-trichloroethane

The first composition is applied onto the surface of bare 12 mm small VISION™ stent (available from Guidant Corporation). Coating is sprayed and dried to form a primer layer. A spray coater is used having a 0.014 round nozzle maintained at ambient temperature with a feed pressure 2.5 psi (0.17 atm) and an atomization pressure of about 15 psi (1.02 atm). Coating is applied at 20 ug per pass, in between which the stent is dried for 10 seconds in a flowing air stream at 50° C. Approximately 120 ug of wet coating is applied. The stents are baked at 80° C. for one hour, yielding a primer layer composed of approximately 100 ug of coating.

A drug reservoir layer is applied onto the primer layer, using the same spraying technique, equipment, and formulation used for the applying the primer. A second composition is prepared by mixing the following components:
2.0 mass % of the polymer of example 4
1.0 mass % of paclitaxel
the balance, a 50/50 blend of chloroform and 1,1,2-trichloroethane

Coating is applied at 20 ug per pass, in between which the stent is dried for 10 seconds in a flowing air stream at 50° C. Approximately 100 ug of wet coating is applied. The stents are baked at 60° C. for one hour, yielding a drug reservoir layer composed of approximately 80 ug of coating.

While particular embodiments of the present invention have been shown and described, it will be obvious to those skilled in the art that changes and modifications can be made without departing from the embodiments of this invention in its broader aspects and, therefore, the appended claims are to encompass within their scope all such changes and modifications as fall within the true spirit and scope of the embodiments of this invention. Additionally, various embodiments have been described above. For convenience's sake, combinations of aspects composing invention embodiments have been listed in such a way that one of ordinary skill in the art may read them exclusive of each other when they are not necessarily intended to be exclusive. But a recitation of an aspect for one embodiment is meant to disclose its use in all embodiments in which that aspect can be incorporated without undue experimentation. In like manner, a recitation of an aspect as composing part of an embodiment is a tacit recognition that a supplementary embodiment exists in that specifically excludes that aspect. All patents, test procedures, and other documents cited in this specification are fully incorporated by reference to the extent that this material is consistent with this specification and for all jurisdictions in which such incorporation is permitted.

Moreover, some embodiments recite ranges. When this is done, it is meant to disclose the ranges as a range, and to disclose each and every point within the range, including end points. For those embodiments that disclose a specific value or condition for an aspect, supplementary embodiments exist that are otherwise identical, but that specifically exclude the value or the conditions for the aspect.

What is claimed is:

1. A polymeric material having K_{A}, K_{B}, K_{C}, K_{D}, or K_{E}, less than or equal to 0.01, 0.02, 0.04, 0.06, 0.08, 0.1, 0.15, 0.2, 0.25, 0.3, 0.35, 0.4, 0.45, 0.5, 0.55, 0.6, 0.65, or 0.7

2. The polymeric material of claim 1 having K_{A} less than or equal to 0.1.

3. The polymeric material of claim 1 having K_{A} less than or equal to 0.2.

4. The polymeric material of claim 1 having K_{A} less than or equal to 0.5.

5. The polymeric material of claim 1 having K_{D} less than or equal to 0.3.

6. The polymeric material of claim 1 having K_{D} less than or equal to 0.5.

7. The polymeric material of claim 1 having K_{D} less than or equal to 0.6.

8. The polymeric material of claim 1 having K_{E}, less than or equal to 0.1.

9. The polymeric material of claim 1 having K_{E} less than or equal to 0.2.

10. The polymeric material of claim 1 having K_{E} less than or equal to 0.5.

11. The polymeric material of claim 1 wherein the polymeric material has a polydispersity index between about 2.2 and about 20.

12. The polymeric material of claim 11 wherein the polymeric material has a polydispersity index between about 2.5 and about 15.

13. The polymeric material of claim 3 wherein the polymeric material has a polydispersity index between about 2.2 and about 20.

14. The polymeric material of claim 7 wherein the polymeric material has a polydispersity index between about 2.2 and about 20.

15. The polymeric material of claim 14 wherein the polymeric material has a polydispersity index between about 2.5 and about 15.

16. The polymeric material of claim 15 wherein the polymeric material has a polydispersity index between about 2.8 and about 12.5.

17. The polymeric material of claim 1 wherein the polymeric material comprises a polymer or a blend of polymers.

18. The polymeric material of claim 17 wherein the polymer is selected from a group consisting of include poly(D,L-lactide), Poly(D-lactide), poly(L-lactide), poly(D,L-lactic acid), poly(D-lactic acid), poly(L-lactic acid), poly(L-lactide-co-D,L-lactide), poly(glycolide), poly(D,L-lactide-co-glycolide), poly(caprolactone), poly(L-lactide-co-caprolactone), poly(glycolide-co-caprolactone), poly(3-hydroxybutyrate), poly(4-hydroxybutyrate), poly(3-hydroxyvalerate), poly(hydroxybutyrate-co-valerate), poly(dioxanone), poly(trimethylene carbonate), poly(D,L-lactide-co-trimethylene carbonate), poly(ester amides), poly(iminocarbonates), poly(carbonates) derived from tyrosine, poly(arylates) derived from tyrosine, and combinations thereof.

19. The polymeric material of claim 17 wherein the blend comprises 2 to 10 fractions of polymers with different average weight average molecular weight.

20. The polymeric material of claim 3 wherein the polymeric material has a polydispersity index between about 2.5 and about 15.

21. The polymeric material of claim 20 wherein the polymeric material comprises a polymer or a blend of polymers.

22. The polymeric material of claim 21 wherein the blend comprises 2 to 10 fractions of polymers with different average weight average molecular weight.

23. The polymeric material of claim 7 wherein the polymeric material comprises a polymer or a blend of polymers.

24. The polymeric material of claim 23 wherein the polymer is selected from a group consisting of include poly(D,L-lactide), Poly(D-lactide), poly(L-lactide), poly(D,L-lactic acid), poly(D-lactic acid), poly(L-lactic acid), poly(L-lactide-co-D,L-lactide), poly(glycolide), poly(D,L-lactide-co-glycolide), poly(caprolactone), poly(L-lactide-co-caprolactone), poly(glycolide-co-caprolactone), poly(3-hydroxybutyrate), poly(4-hydroxybutyrate), poly(3-hydroxyvalerate), poly(hydroxybutyrate-co-valerate), poly(dioxanone), poly(trimethylene carbonate), poly(D,L-lactide-co-trimethylene carbonate), poly(ester amides), poly(iminocarbonates), poly(carbonates) derived from tyrosine, poly(arylates) derived from tyrosine, and combinations thereof.

25. The polymeric material of claim 24 wherein the blend comprises 2 to 10 fractions of polymers with different average weight average molecular weight.

26. A method for fabricating a coating for an implantable medical device comprising depositing the polymeric material of claim 1 on at least a portion of the device.

27. A method for fabricating a coating for an implantable medical device comprising depositing the polymeric material of claim 3 on at least a portion of the device.

28. A method for fabricating a coating for an implantable medical device comprising depositing the polymeric material of claim 7 on at least a portion of the device.

29. A method for fabricating a coating for an implantable medical device comprising depositing the polymeric material of claim 13 on at least a portion of the device.

30. A method for fabricating a coating for an implantable medical device comprising depositing the polymeric material of claim 14 on at least a portion of the device.

31. A method for fabricating a coating for an implantable medical device comprising depositing the polymeric material of claim 16 on at least a portion of the device.

32. A method for fabricating a coating for an implantable medical device comprising depositing the polymeric material of claim 20 on at least a portion of the device.

33. A method for fabricating a coating for an implantable medical device comprising depositing the polymeric material of claim 22 on at least a portion of the device.

34. A method for fabricating a coating for an implantable medical device comprising depositing the polymeric material of claim 23 on at least a portion of the device.

35. A method for fabricating a coating for an implantable medical device comprising depositing the polymeric material of claim 24 on at least a portion of the device.

36. A method for fabricating a coating for an implantable medical device comprising depositing the polymeric material of claim 25 on at least a portion of the device.

37. The method of claim 26 wherein the implantable device is a stent.

38. The method of claim 30 wherein the implantable device is a stent.

39. The method of claim 33 wherein the implantable device is a stent.

40. The method of claim 36 wherein the implantable device is a stent.

41. A coating for an implantable medical device comprising the polymeric material of claim 1.

42. A coating for an implantable medical device comprising the polymeric material of claim 3.

43. A coating for an implantable medical device comprising the polymeric material of claim 7.

44. A coating for an implantable medical device comprising the polymeric material of claim 13.

45. A coating for an implantable medical device comprising the polymeric material of claim 14.

46. A coating for an implantable medical device comprising the polymeric material of claim 16.

47. A coating for an implantable medical device comprising the polymeric material of claim 20.

48. A coating for an implantable medical device comprising the polymeric material of claim 22.

49. A coating for an implantable medical device comprising the polymeric material of claim 23.

50. A coating for an implantable medical device comprising the polymeric material of claim 24.

51. A coating for an implantable medical device comprising the polymeric material of claim 25.

52. A coating for an implantable medical device comprising the polymeric material of claim 26.

53. A coating for an implantable medical device comprising the polymeric material of claim 30.

54. A coating for an implantable medical device comprising the polymeric material of claim 33.

55. A coating for an implantable medical device comprising the polymeric material of claim 36.

56. A polymer with an improved degradation-versus-time profile.

57. The polymer of claim 56 wherein the improvement is greater than 1, 5, 10, 15, 20, 25, 40, 50, 60, 70, 80, 90, 100%, 200%, 300%, 400%, 500%, 600%, 700%, 800%, 900%, or 1000%.

58. The polymer of claim 56 wherein the improvement is greater than 20%.

59. The polymer of claim 56 wherein the improvement is greater than 50%.

60. The polymer of claim 56 wherein the improvement is greater than 80%.

61. The polymer of claim 56 wherein the improvement is greater than 100%.

62. The polymer of claim 56 wherein the improvement is greater than 500%.

63. The polymer of claim 56 wherein the improvement is greater than 1000%.

64. A polymer composition comprising mixtures of l-PLA and d,l-PLA.

65. The polymer composition of claim 64 wherein the d,l-PLA has a weight average molecular weight of 80,000 to 600,000.

66. The polymer composition of claim 65 wherein the glass transition temperature of the d,l-PLA is 50-55° C.

67. The polymer composition of claim 64 wherein the glass transition temperature of the d,l-PLA is 50-55° C.

68. The polymeric composition of claim 67 additionally comprising d,l-PLA oligomers having a weight average molecular weight of 1,000 to 50,000.

69. The polymeric composition of claim 64 additionally comprising d,l-PLA oligomers having a weight average molecular weight of 1,000 to 50,000.

70. The polymeric composition of claim 68 additionally comprising di-lactide monomer or d,l-PLA oligomers.

71. The polymeric composition of claim 64 additionally comprising di-lactide monomer or d,l-PLA oligomers.

72. The polymeric composition of claim 71 additionally comprising polyethylene glycol.

73. The polymeric composition of claim 64 additionally comprising polyethylene glycol.

74. The polymeric composition of claim 73 wherein the weight average molecular weight of the polyethylene glycol is 1,000-50,000.

75. The polymeric composition of claim 73 wherein the weight average molecular weight of the polyethylene glycol is 1,000-50,000.

76. The polymeric composition of claim 73 additionally comprising PEG-PLA di-block or tri-block copolymers.

77. The polymeric composition of claim 64 additionally comprising PEG-PLA di-block or tri-block copolymers.

78. A medical device comprising the polymeric composition of claim 76.

79. The medical device of claim 78 comprising a coating having a polymeric composition.

80. The polymeric composition of claim 64 containing a drug.

81. The polymeric composition of claim 76 containing a drug.

82. The polymeric composition of claim 64 not containing a drug.

83. The polymeric composition of claim 76 not containing a drug.

84. A medical device comprising a substrate wherein 50-100% of the substrate consists of the polymeric material of claim 1.

85. A medical device comprising a substrate wherein 50-100% of the substrate consists of the polymeric material of claim 3.

86. A medical device comprising a substrate wherein 50-100% of the substrate consists of the polymeric material of claim 5.

87. A medical device comprising a substrate wherein 50-100% of the substrate consists of the polymeric material of claim 13.

88. A medical device comprising a substrate wherein 50-100% of the substrate consists of the polymeric material of claim 15.

89. A medical device comprising a substrate wherein 50-100% of the substrate consists of the polymeric material of claim 18.

90. A medical device comprising a substrate wherein 50-100% of the substrate consists of the polymeric material of claim 25.
